(19) United States
(12) Patent Application Publication
(10) Pub. No.: US 2008/0316373 A1
(43) Pub. Date: Dec. 25, 2008

(54) PROJECTION TYPE IMAGE DISPLAY DEVICE

(75) Inventor: Mitsuoki HISHIDA, Kaidu-Shi (JP)

Correspondence Address: DITTHAVONG MORI & STEINER, P.C., 918 Prince St., Alexandria, VA, 22314, US

(73) Assignees: Sanyo Electric Co., Ltd., Moriguchi-shi (JP); SANYO Optec Design Co., Ltd., Tokyo (JP)

(21) Appl. No.: 12/108,971

(22) Filed: Apr. 24, 2008

(30) Foreign Application Priority Data
Apr. 24, 2007 (JP) 2007-114062

(51) Int. Cl. H04N 9/31

(52) U.S. Cl. 348/744; 348/E09.025

(57) ABSTRACT

A beam modulated by a video signal scans a projected region. A spot size of the beam in the projected region is set to be smaller than a width of one pixel in a direction vertical to a scanning direction. A group of pixels disposed in the scanning direction is scanned by the beam a plurality of times to display one screen. A scanning position of the beam with regard to the group of the pixels is shifted in the direction vertical to the scanning direction for every scanning turn to display one screen.

This application claims priority under 35 U.S.C. Section 119 of Japanese Patent Application No. 2007-114062 filed Apr. 24, 2007, entitled “PROJECTION TYPE IMAGE DISPLAY DEVICE”.

### BACKGROUND OF THE INVENTION

1. Field of the Invention

The present invention relates to a projection type image display device for displaying an image by causing a beam to scan on a projected plane, and is preferable particularly in use for a case where a laser light source serves as a light emitting source.

2. Description of the Related Art

Today, scanning type laser projectors for displaying an image by scanning a screen plane with laser light have been developed. This type of laser projectors have a problem that speckle occurs to a projected image due to interference of the laser light. Various methods have been investigated to resolve this problem.

One known method for suppressing the speckle is to reduce a size of a diameter of a spot on the screen plane. In general, in the conventional projectors, the diameter of the spot on the screen plane is set to be nearly equal to a width of one pixel or slightly greater than that. To the contrary, the speckle can be suppressed by making the diameter of the spot smaller than the width of pixel.

However, when the diameter of the spot is reduced as mentioned above, a region that cannot be scanned by the spot increases in the projected region, and another problem eventually arises that unevenness on display occurs to the projected image.

FIGS. 6A and 6B are diagrams schematically showing scanning states of a beam spot for each of pixels when the diameter of the spot is varied, and projected images at that time. As illustrated in FIG. 6A, when the diameter of the spot is made smaller than a width of one pixel, a region of a gap that cannot be scanned by the spot becomes greater. For this reason, the unevenness on display in a line-shape occurs to the projected image as shown at right part of FIG. 6A. Furthermore, when the diameter of the spot is made smaller as shown in FIG. 6B, the region of the gap is further widened, and the unevenness on display in the line-shape occurring to the projected image becomes more remarkable as shown on a right side of FIG. 6B. As mentioned, when the diameter of the spot is made smaller than the width of one pixel, the speckle is suppressed while the unevenness on display occurs to the projected image, causing problems.

### SUMMARY OF THE INVENTION

An object of the present invention is to smoothly suppress unevenness on display caused due to a region of a gap not scanned by a spot and, at the same time, to suppress generation of speckle by reducing a diameter of a beam spot.

A projection type image display device according to a first aspect of the present invention is to display an image in a projected region by scanning a projected region with a beam modulated according to a video signal. The projection type image display device according to the first aspect comprises a light source for emitting the beam and an optical system for adjusting a shape of the beam in the projected region. The optical system makes a size of a spot of the beam in the projected region smaller than a width of one pixel set in the projected region in a direction vertical to a scanning direction of the beam. Furthermore, the projection type image display device according to the first aspect comprises a scanning section for scanning the projected region with the beam and a control circuit for controlling the scanning section. The control circuit controls the scanning section so that the beam scans a group of the pixels disposed in the scanning direction a plurality of times to display one screen, and controls the scanning section so that a scanning position of the beam with regard to the group of the pixels is shifted in a direction vertical to the scanning direction for every scanning turn to display one screen.

According to this aspect, since the spot size of the beam in the projected region is set to be smaller than the width of one pixel in a direction vertical to the scanning direction, the speckle in the projected image is suppressed. Furthermore, since a scanning position of each pixel is shifted in terms of time in the direction vertical to the scanning direction, the region of the gap shown in FIGS. 6A, 6B is reduced. Therefore, the unevenness on display in the line-shape caused due to the region of the gap is suppressed.

In this aspect, when the spot size of the beam in the projected region is not more than 1/N and greater than 1/(N+1) (N is a natural number equal to or greater than 2) of the width of one pixel in the direction vertical to the scanning direction, preferably, the beam scans not less than N different places in the direction vertical to the scanning direction of the pixels disposed in the scanning direction. Thereby, the region of the gap shown in FIGS. 6A and 6B can be eliminated. Accordingly, the unevenness on display in the line-shape caused due to the region of the gap can be eliminated.

An image display method according to a second aspect of the present invention is a method for displaying a beam scanning type image in which the image is displayed in a projected region by scanning the projected region with a beam modulated according to the video signal. The image display method according to the second aspect adjusts a spot size of the beam in the projected region to be smaller than a width of one pixel set in the projected region in a direction vertical to a scanning direction of the beam; a group of the pixels disposed in scanning direction are scanned a plurality of times by the beam to display one screen; and a scanning position of the beam with regard to the group of the pixels is shifted in the direction vertical to the scanning direction for every scanning turn to display one screen.

According to the second aspect, since the spot size of the beam in the projected region is set to be smaller than the width of one pixel in the direction vertical to the scanning direction, the speckle in the projected image is suppressed. Furthermore, since the scanning position of each pixel is shifted in the direction vertical to the scanning direction in terms of time, the regions of the gap shown in FIGS. 6A and 6B are reduced. Therefore, the unevenness on display in the line-shape caused due to the region of the gap is suppressed.

### BRIEF DESCRIPTION OF THE DRAWINGS

The object and other objects, and novel features of the present invention will be fully understood by reading embodiments described below together with attached drawings shown below.

FIG. 1 shows a configuration of a laser projector according to an embodiment;

FIG. 2 is a diagram for explanation of scanning operation of projection laser light according to the embodiment;

FIGS. 3A and 3B are diagrams for explanation of scanning control of the projection laser light according to the embodiment;

FIGS. 4A through 4C are diagrams for explanation of other scanning control of the projection laser light according to the embodiment;

FIG. 5 is a flowchart showing a processing flow of scanning control according to the embodiment; and

FIG. 6 is a diagram for explanation of states of a projected image when a diameter of a beam spot is made smaller than a width of one pixel.

However, the drawings are illustrative and for explanation only, and do not limit the scope of the present invention.

### DESCRIPTION OF PREFERRED EMBODIMENTS

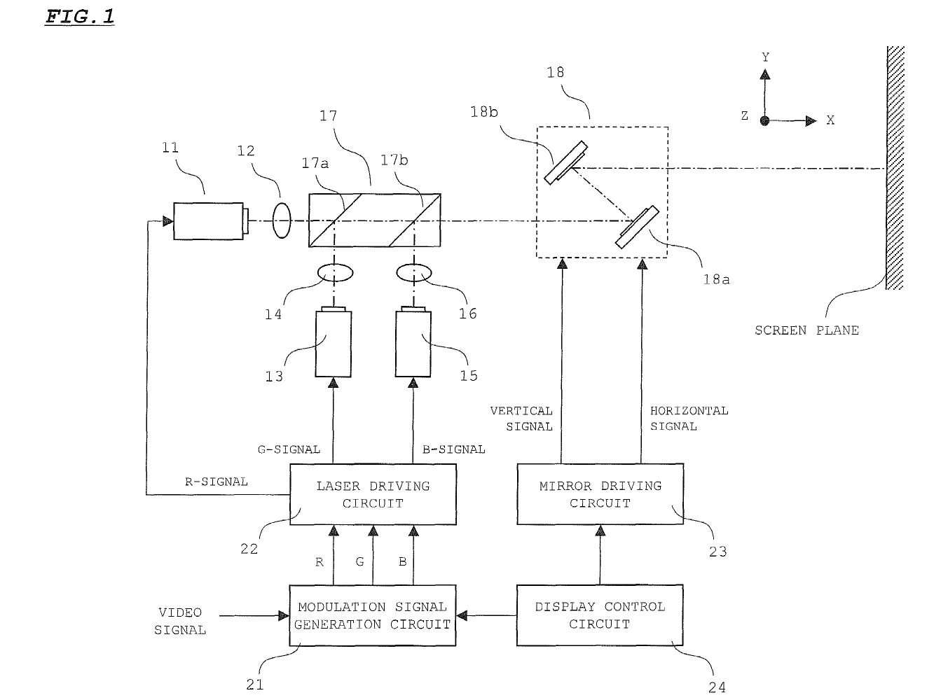

A configuration of the laser projector according to the embodiment is shown in FIG. 1.

In the drawing, reference number 11 denotes a laser light source for emitting laser light in a red wavelength band (hereinafter, referred to as “R-light”). Reference number 12 denotes an optical system for shaping the R-light emitted from the laser light source 11 to a beam spot with a predetermined diameter on the screen plane. Reference number 13 denotes a laser light source for emitting laser light in a green wavelength band (hereinafter, referred to as “G-light”). Reference number 14 denotes an optical system for shaping the G-light emitted from the laser light source 13 to a beam spot with a predetermined diameter on the screen plane. Reference number 15 denotes a laser light source for emitting laser light in a blue wavelength band (hereinafter, referred to as “B-light”). Reference number 16 denotes an optical system for shaping the B-light emitted from the laser light source 15 to a beam spot with a predetermined diameter on the screen plane. Optical systems 12, 14, and 16 comprise an aperture and a lens for shaping the beam.

The optical axes of the R-light, the G-light, and the B-light transmitted through the optical systems 12, 14, and 16 are aligned by a dichroic prism array 17. That is, the R-light transmits through two wavelength selective mirror faces 17a and 17b disposed in the dichroic prism array 17. The G-light is reflected by the mirror face 17a. The reflected G-light transmits through the mirror face 17b. The B-light is reflected by the mirror face 17b. The laser light sources 11, 13, and 15 and the dichroic prism array 17 are disposed at a position where the optical axes of the R-light, the G-light, and the B-light that have transmitted through the dichroic prism array 17 are aligned.

Reference number 18 denotes a driving mirror unit for scanning the screen plane with R-light, G-light, and B-light having the optical axes aligned by the dichroic prism array 17, in a two-dimensional direction. The driving mirror unit 18 includes a first MEMS (Micro Electro Mechanical Systems) mirror 18a and a second MEMS mirror 18b. The first MEMS mirror 18a causes projection laser light having the color-synthesized R-light, G-light, and B-light to scan the screen plane in a horizontal direction (in a Y-axis direction in the drawing). The second MEMS mirror 18b causes the projection laser light to scan in a vertical direction (in a Z-axis direction in the drawing). The projection laser light from the dichroic prism array 17 is reflected by the first MEMS mirror 18a to the second MEMS mirror 18b. After that, the projection laser light is reflected by the second MEMS mirror 18b in a screen direction.

A modulation signal generation circuit 21 generates a signal for modulating the R-light, the G-light, and the B-light based on an input video signal and outputs a generated modulation signal to a laser driving circuit 22. The laser driving circuit 22 generates a signal for driving the laser light sources 11, 13, and 15 based on the input modulation signal and drives the laser light sources 11, 13, and 15 based on the signal generated by the laser driving circuit 22. Thereby, intensity of the R-light, the G-light, and the B-light output from the laser light sources 11, 13, and 15 is modulated according to an input video signal.

A mirror driving circuit 23 supplies a driving signal that causes the projection laser light to scan the screen plane in the two-dimensional direction (in the horizontal direction and vertical direction) to the first and the second MEMS mirrors 18a and 18b, as will be described later. A display control circuit 24 controls various processing relating to image projection such as synchronization of scanning operation of the projection laser light by the mirror driving circuit 23 with modulation operation of the R-light, the G-light, and the B-light by the modulation signal generation circuit 21 and the laser driving circuit 22, etc.

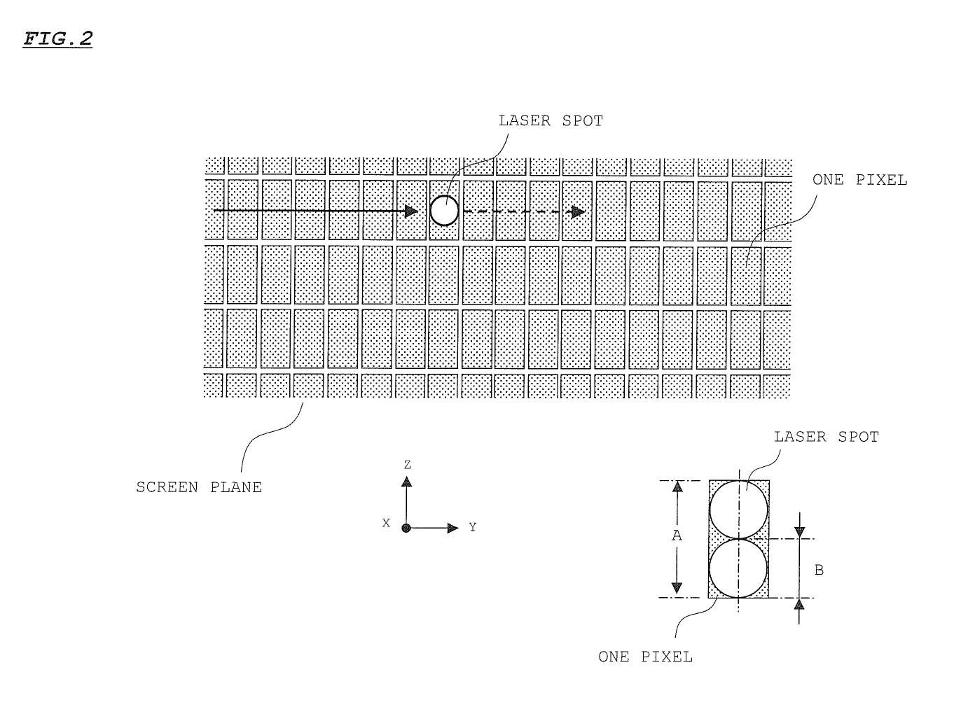

Referring now to FIG. 2, the scanning operation of the projection laser light on the screen plane will be explained.

As shown in FIG. 2, pixels of a predetermined size are set in the projected region on the screen plane. The projection laser light scans each of pixels disposed on a scanning line in a horizontal direction (in a Y-axis direction in the drawing). Upon completion of scanning the scanning line, a scanning line located one stage lower than the scanning line is scanned in the horizontal direction. The scanning is repeated from the scanning line at a top stage to the scanning line at a bottom stage. When scanning of the scanning line at the bottom stage is complete, the scanning operation is executed from the scanning line at the top stage in the same manner.

Here, a diameter of a spot of the projection laser light on the projected region is set to be smaller than a width of one pixel in a direction vertical to the scanning line (in a Z-axis direction in FIG. 2). In the example shown on right lower side of the drawing, the diameter of the spot B is set to be ½ of the width of one pixel A. The diameter of the spot is set by adjusting designs of the lens for shaping the beam or the like included in the above-mentioned optical systems 12, 14, and 16.

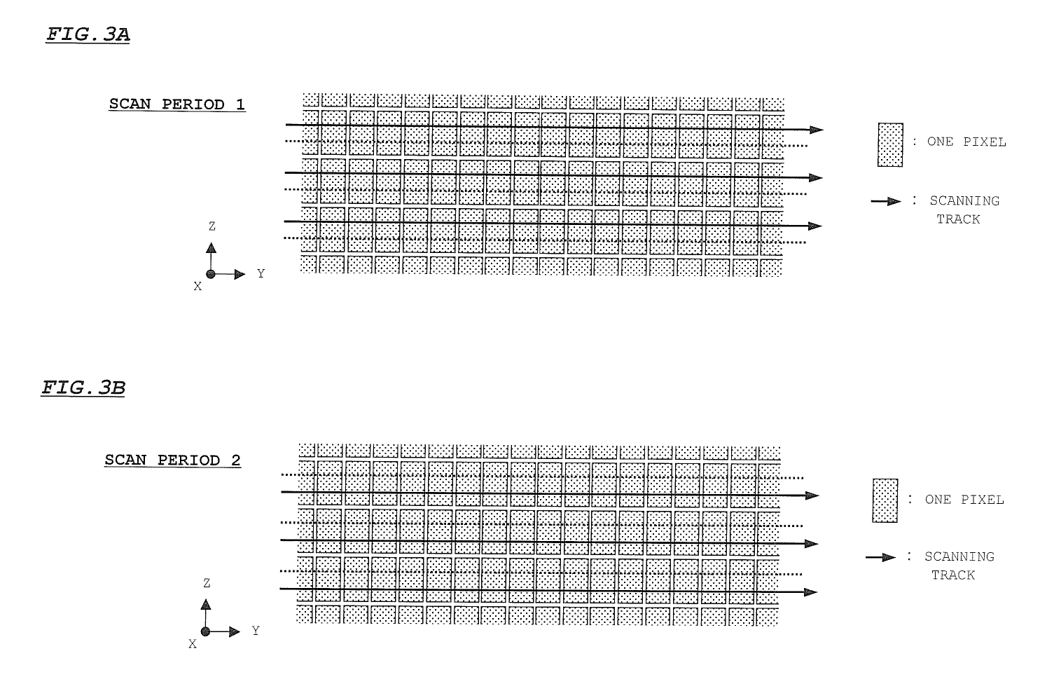

Referring to FIGS. 3A and 3B, the scanning control of the projection laser light on the screen plane will be explained. Here, a scanning position (scanning track) for each pixel is shifted in a direction vertical to the scanning line (in a Z-axis direction in FIGS. 3A and 3 B) in terms of time. Each pixel is scanned at two different positions in the direction vertical to the scanning line. That is, in scan period 1 shown in FIG. 3A, a center of an upper half region of each pixel is scanned by the projection laser light. After that, in scan period 2 shown in FIG. 3B, a center of a lower half region of each pixel is scanned by the projection laser light. After scan period 2 is complete, in the subsequent scan period, the upper half region of each pixel is scanned by the projection laser light in the same manner as in the case of FIG. 3A. Following this, similarly, the scanning operation at the upper half region of each pixel and the scanning operation at the lower half region are switched one after another in each scan period.

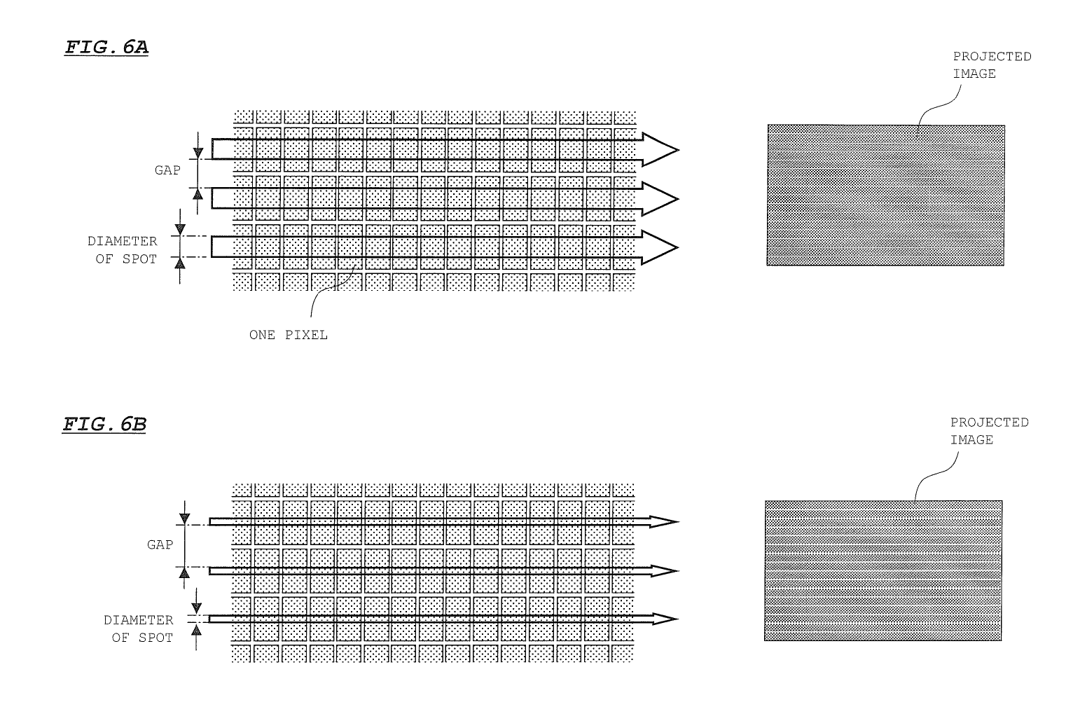

According to the scanning control shown in FIGS. 3A and 3B, when the diameter of the spot B is set to be ½ of the width of one pixel A as illustrated on the right lower side of FIG. 2, a region of a gap not scanned by the beam spot (see FIGS. 6A and 6B) can be eliminated. Therefore, in this case, the unevenness on display of the projected image caused due to the region of the gap can be eliminated.

When the diameter of the spot B is set to be, for example, ⅓ of the width of one pixel A shown in FIG. 2, and the scanning control shown in FIGS. 3A and 3B is executed, the region of the gap not scanned by beam spot will be generated. Also in this case, however, a width of the region of the gap becomes much smaller than that in the conventional scanning control in which the scanning position for each pixel is not changed for every scan period. Therefore, also in this case, the unevenness on display of the projected image caused due to the region of the gap can be effectively suppressed.

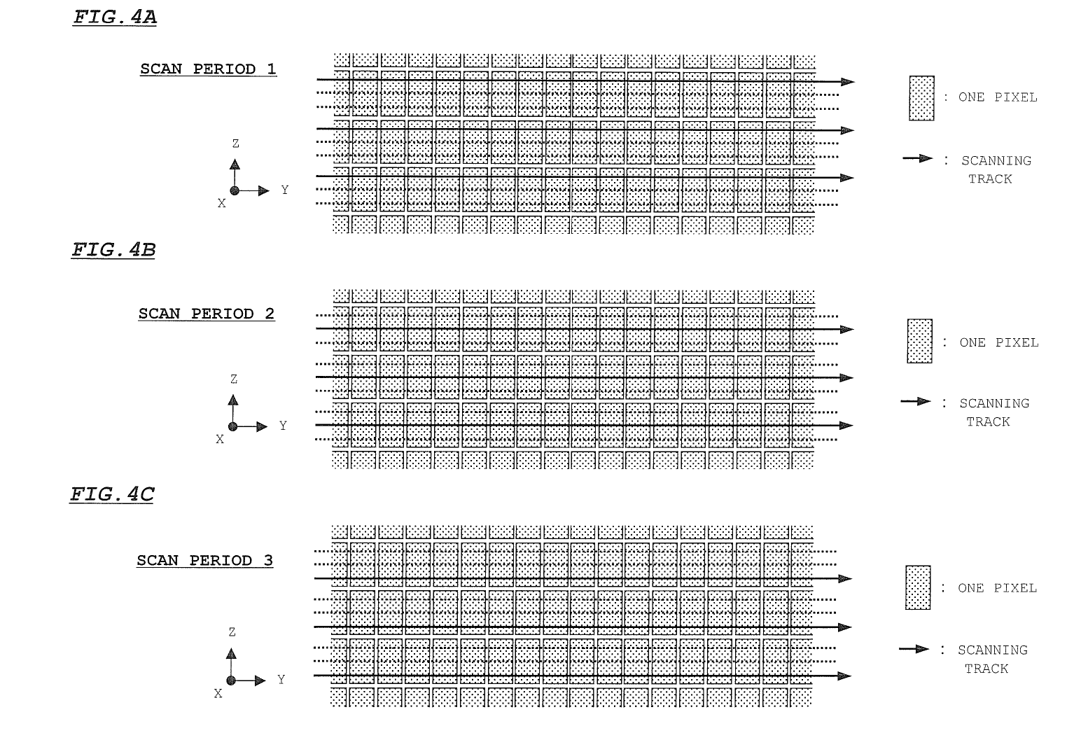

When the diameter of the spot B is set to be ⅓ of width of one pixel A as mentioned, as shown in FIGS. 4A, 4B, and 4C, the scanning control is changed so that the scanning operation is sequentially shifted from the top stage through an intermediate stage to the bottom stage in each pixel for every scan period. Thereby, the region of the gap not scanned by the beam spot can be eliminated. Furthermore, when the diameter of the spot B is set to be ½ of the width of one pixel A as shown in the example shown on the right lower side of FIG. 2, the scanning operation may be sequentially shifted from the top stage through the intermediate stage to the bottom stage in each pixel for every scan period as shown in FIGS. 4A, 4B, and 4C.

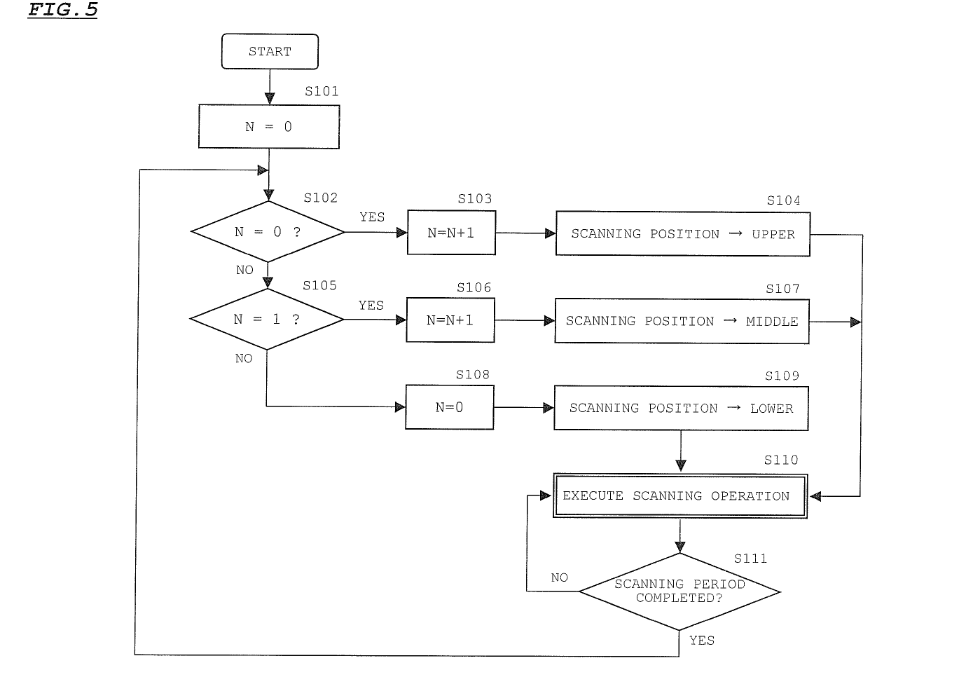

FIG. 5 is a diagram showing a processing flow in the scanning control shown in FIG. 4. The processing is carried out in the mirror driving section 23.

When the scanning control is started, first, at S101, a variable N is set to be zero. Next, at S102, it is judged whether the variable N is N=0. When the judgment is YES, 1 is added to the variable N at S103, and the scanning position (scanning track) for each pixel is set to be at the top stage (see FIG. 4A) at S104. Following this, at S110, the scanning operation of the projection laser light is executed for the projected region. In this case, the scanning position (scanning track) of the beam spot is at the upper stage position of each pixel. The scanning operation is repeated until it is judged at S111 that predetermined scan period is complete while the scanning line is changed stage by stage. For example, when all the pixels in the projected region are scanned at 1/60 seconds, scan period of one unit is set to be, for example, 1/20 seconds.

When it is judged that the scan period is completed at S111, the processing returns to S102 and it is judged whether the variable N is N=0. When the judgment is NO, it is judged at S105 whether the variable N is N=1. When the judgment is YES, 1 is added to the variable N at S106, and the scanning position (scanning track) for each pixel is set to the intermediate stage (see FIG. 4B) at S107. Following this, the scanning operation of the projection laser light for the projected region is executed at S110. In this case, the scanning position (scanning track) of the beam spot is at the intermediate stage position of each pixel. The scanning operation is repeated until it is judged at S111 that the scan period (e.g., 1/20 seconds) is complete while the scanning line is changed stage by stage.

After that, when it is judged at S111 that the scan period is complete, the processing returns again to S102, and it is judged whether the variable N is N=0. When the judgment is NO, it is judged at S105 whether the variable N is N=1. When the judgment is also NO, the variable N is reset to be N=0 at S108, and at S109, the scanning position (scanning track) for each pixel is set to the lower stage position (see FIG. 4C). Following this, at S110, the scanning operation of the projection laser light for the projected region is executed. In this case, the scanning position (scanning track) of the beam spot is at the lower stage position of each pixel. The scanning operation is repeated until it is judged at S111 that the scan period (e.g., 1/20 seconds) is complete while the scanning line is changed stage by stage.

As mentioned above, according to the present embodiment, the speckle in the projected image is suppressed when the diameter of the spot of the projection laser light in the projected region is set to be smaller than the width of one pixel in the direction vertical to the scanning line. Furthermore, since the scanning position (scanning track) of each pixel is shifted in the direction vertical to the scanning line in terms of time, the region of the gap not scanned by the beam spot can be reduced. Therefore, the unevenness on display in the line-shape caused due to the region of the gap can be suppressed.

Furthermore, as mentioned above, when the diameter of the spot of the projection laser light in the projected region is ½ or ⅓ of the width of one pixel in the direction vertical to the scanning line, and when control is performed so that each pixel is scanned at two or three different places in the direction vertical to the scanning line, the region of the gap caused among the scanning lines (see FIGS. 6A and 6B) can be eliminated. Therefore, in this case, the unevenness on display in line-shape caused due to the region of the gap can be eliminated.

As mentioned, according to the present embodiment, the unevenness on display caused due to the region of the gap can be smoothly suppressed and, at the same time, the speckle can be suppressed by reduction in the size of the spot.

The above-mentioned embodiments should not be construed as limiting the present invention, and various modifications can be made to embodiments of the present invention in addition to those mentioned above. For example, in the above-mentioned embodiments, while the first and second MEMS mirrors 18a and 18b are used for the projection laser light to scan, a Galvano mirror, a lens actuator, or the like can be used for the projection laser light to scan. Furthermore, one MEMS mirror that can perform two-dimensional driving can be also used for the projection laser light to scan.

In addition, various alterations can be applied appropriately to embodiments of the present invention within the scope of technical concepts shown in the scope of claims.

What is claimed is:

1. A projection type image display device for displaying an image in a projected region by scanning the projected region with a beam modulated according to a video signal, the projection type image display device comprising:
a light source for emitting the beam;
an optical system for adjusting a shape of the beam in the projected region, the optical system making a spot size of the beam in the projected region smaller than a width of one pixel set in the projected region in a direction vertical to a scanning direction of the beam;
a scanning section that scans the projected region with the beam; and
a control circuit for controlling the scanning section, wherein the control circuit controls the scanning section so that the beam may scan a group of the pixels disposed in the scanning direction a plurality of times to display one screen, and controls the scanning section so that the scanning position of the beam with regard to the group of pixels may be shifted in the direction vertical to the scanning direction for every scanning turn to display one screen.

2. The projection type image display device according to claim 1, wherein pixels disposed in the scanning direction are scanned by the beam at not less than N different places in the direction vertical to the scanning direction when a spot size of the beam in the projected region is not more than 1/N and greater than 1/(N+1) (N is a natural number equal to or greater than 2) of the width of one pixel in the direction vertical to the scanning direction.

3. The projection type image display device according to claim 1, wherein the light source has at least three laser light sources for emitting laser light in a red wavelength band, laser light in a green wavelength band, and laser light in a blue wavelength band, and
the projection type image display device further comprises a wavelength selective optical element that aligns an optical axis of the laser light from each of the laser light sources.

4. A beam scanning type image display method for displaying an image in a projected region by scanning the projected region with a beam modulated according to a video signal, comprising steps of:
adjusting a spot size of the beam in the projected region to make the spot size of the beam smaller than a width of one pixel set in the projected region in a direction vertical to a scanning direction of the beam;
scanning a group of the pixels disposed in the scanning direction with the beam a plurality of times to display one screen; and
shifting a scanning position of the beam with regard to the group of pixels in the direction vertical to the scanning direction for every scanning turn to display one screen.

5. The beam scanning type image display method according to claim 4, wherein pixels disposed in the scanning direction are scanned by the beam at not less than N different places in the direction vertical to the scanning direction when the spot size of the beam in the projected region is not more than 1/N and greater than 1/(N+1) (N is a natural number equal to or greater than 2) of the width of one pixel in the direction vertical to the scanning direction.
